(19) United States
(12) Patent Application Publication
(10) Pub. No.: US 2013/0180924 A1
(43) Pub. Date: Jul. 18, 2013

(54) SYSTEMS AND METHODS FOR TREATING WASTEWATER

(71) Applicants: John W. Macpherson, JR., Bothell, WA (US); Karl E. Bruegeman, Everett, WA (US)

(72) Inventors: John W. Macpherson, JR., Bothell, WA (US); Karl E. Bruegeman, Everett, WA (US)

(73) Assignee: OSW EQUIPMENT & REPAIR INC., Snohomish, WA (US)

(21) Appl. No.: 13/529,966

(22) Filed: Jun. 21, 2012

Related U.S. Application Data
(60) Provisional application No. 61/499,625, filed on Jun. 21, 2011.

(51) Int. Cl. C02F 1/42

(52) U.S. Cl. CPC C02F 1/42
USPC 210/669; 210/202

(57) ABSTRACT

A method of treating wastewater includes treating the wastewater with an additive to generate a treated wastewater, filtering the treated wastewater through a filter system to substantially completely remove residual particulate material and generate filtered wastewater, and processing the filtered wastewater with an ion exchange media to adsorb soluble metals from the filtered wastewater.

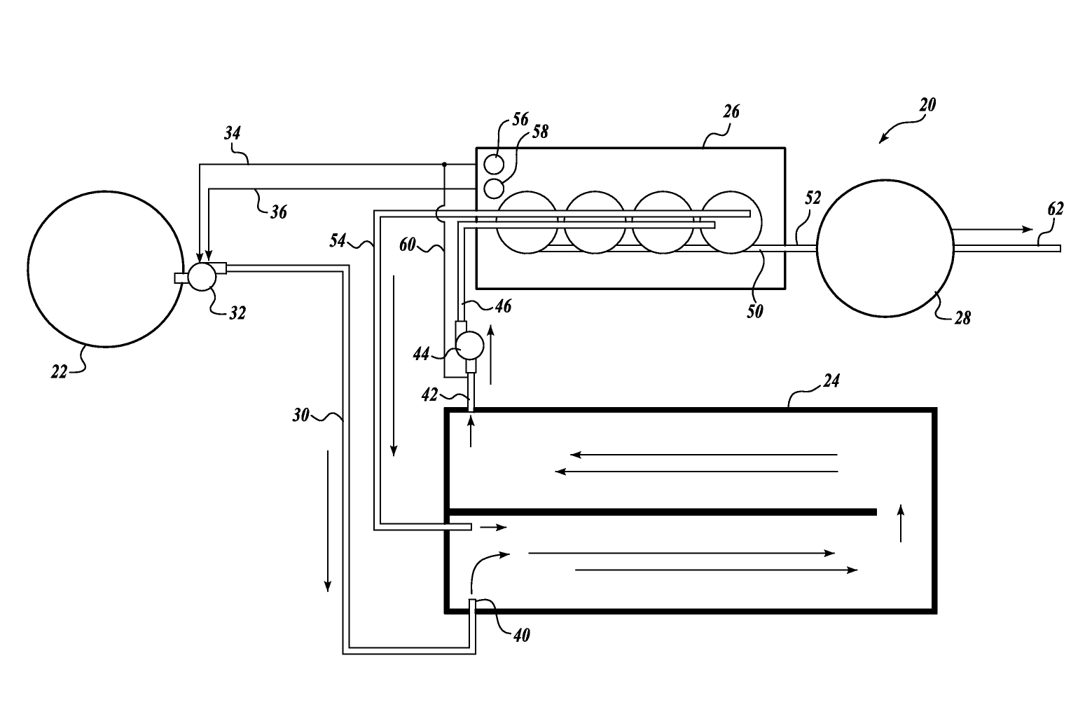

### CROSS-REFERENCE TO RELATED APPLICATION

This application claims the benefit of U.S. Provisional Application No. 61/499,625, filed Jun. 21, 2011, the disclosure of which is expressly incorporated herein by reference in its entirety.

### BACKGROUND

In terrestrial mining for precious metals (e.g., gold, silver, platinum, and palladium mining), a significant amount of processing water is used, for example, to move and process soil containing precious metals. Terrestrial mining processes can also result in groundwater dewatering.

Recovered process water tends to be turbid, containing dispersed particulate matter that may include particulate precious metals. For environmental reasons, this turbid water must be treated to remove suspended sediment and other impurities, such as toxic metals, before being discharged to rivers and streams.

The recovered water also may contain dissolved precious metals. Although present as an extremely small amount of metal ions, if recovered from large amounts of processing water, the accumulation of the recovered precious metal ions can be very valuable. For example, 0.5 mg/liter dissolved gold in an exemplary flow of 500 gpm would equal three pounds of gold per day recovered.

Currently, low concentrations of ionic precious metals, such as ionic gold, in mining wastewater are not considered to be economically recoverable. The presence of suspended sediment as well as nuisance metal ions (such as iron, copper, lead, zinc, etc.) make soluble gold recovery difficult and costly using commercial recovery methods, namely, carbon adsorption and ion exchange. In that regard, the carbon adsorption process typically requires about an hour of adsorption time in a large adsorption tank. Such a long processing time has not proven to be economically feasible for large amounts of processing water, for example, on the order of 500 gallons per minute, because it requires large holding tanks and economically infeasible amounts of carbon adsorptive media.

Therefore, there exists a need for improved metal ion recovery from wastewater. Improvements in metal ion recovery would not only be advantageous to the precious metal mining industry, but also would enhance the clean-up techniques for toxic metals in industrial storm water and wastewater.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a method of treating wastewater is provided. The method generally includes treating the wastewater with an additive to generate a treated wastewater, filtering the treated wastewater through a filter system to substantially completely remove residual particulate material and generate filtered wastewater, and processing the filtered wastewater with an ion exchange media to adsorb soluble metals from the filtered wastewater.

In accordance with another embodiment of the present disclosure, a system for treating wastewater is provided. The system generally includes a settling tank for settling sediment from wastewater, wherein the wastewater includes an additive, a filter system for filtering the settled wastewater into filtered wastewater, and an ion adsorption system for adsorbing metal ions from the filtered wastewater.

In accordance with another embodiment of the present disclosure, a system for treating wastewater is provided. The system generally includes a settling tank for settling sediment from wastewater, wherein the wastewater includes an additive selected from the group consisting of a coagulant, a co-precipitant, and a mixture thereof, and wherein the settling tank settles at least about 90% of the sediment present in wastewater. The system further includes a filter system for filtering the settled wastewater into filtered wastewater, wherein the filter system filters the sediment present in the settled wastewater to less than about 5 NTU of turbidity present in filtered wastewater. The system further includes an ion adsorption system for adsorbing metal ions from the filtered wastewater.

### DESCRIPTION OF THE DRAWINGS

The foregoing aspects and many of the attendant advantages of this disclosure will become more readily appreciated by reference to the following detailed description, when taken in conjunction with the accompanying drawing, wherein:

The FIGURE is a schematic of a water treatment system in accordance with one embodiment of the present disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

Embodiments of the present disclosure are generally directed to systems and methods for treating wastewater. In particular, the systems and methods described herein can be used for the recovery of metal particulates and metal ions present in wastewater. Referring to the FIGURE, a schematic of a water treatment system is provided.

Although shown and described in the FIGURE as a system for processing mining wastewater, it should be appreciated that other non-mining systems are also within the scope of the present disclosure. For example, an alternate embodiment of an industrial surface water or storm water treatment system is described in greater detail below. In accordance with other embodiments of the present disclosure, the system 20 may be used to process scrubbing water for flue gases, for examples, gases recovered in coal combustion processes that contain undesirable amounts of selenium.

Referring to the illustrated embodiment in the FIGURE, the water treatment system 20 includes a wastewater holding tank 22, a settling tank 24, a filter system 26, and a metal recovery system 28. Wastewater, for example, from a mining process is fed to the wastewater holding tank 22, where it awaits processing. The wastewater is typically turbid water, for example, having a turbidity value in the range of up to about 10,000 nephelometric turbidity units (NTU).

From the holding tank 22, the wastewater is fed to the settling tank 24 via line 30 and pump 32 for settling out the turbidity. As the wastewater is fed to the settling tank 24, additives to the wastewater, such as a coagulant, a co-precipitant, and mixtures thereof, may be mixed into the wastewater to assist in the separation of particulate matter and impurities from the turbid wastewater. In the illustrated embodiment of the present disclosure, a coagulant and a co-precipitant are added at injection sites at pump 32 via lines 34 and 36 (from sources 56 and 58) to generate mixing. However, it should be appreciated that other injection points are within the scope of the present disclosure.

The coagulant assists in the coagulation of fine sediment particles from the turbid wastewater. Suitable additives for assisting in the removal of particulate matter and impurities from the turbid wastewater may include coagulants, including, but not limited to, chitosan, alum, and aluminum chloride, and other proprietary coagulants developed by companies such as GE and Calgon. Because chitosan is not soluble in water, it is generally mixed with a weak organic acid, including, but not limited to, acetic acid, lactic acid, or malic acid, to create a solution.

The co-precipitant assists in the co-precipitation of heavy metals that may be toxic to the environment. A heavy metal is a member of a loosely-defined subset of elements that exhibit metallic properties, which may include, for example, mercury, cadmium, chromium, zinc, lead, arsenic, cobalt, copper, manganese, nickel, tin, and thallium, etc. These heavy metals are generally dangerous to health or the environment when present in harmful quantities. Interestingly, the co-precipitant generally does not cause most of the ionic precious metals to precipitate out. Suitable co-precipitants may include, but not limited to, ferric chloride, aluminum chloride, alum, etc. In some cases, the additives, for example, alum and aluminum chloride, may have both coagulant and co-precipitant properties.

The amount and mix of additives added to the wastewater depends on the turbidity of the wastewater, cost effectiveness, and the desired results of the system 20. As a non-limiting example, about 0.5 to about 2 mg/liter of coagulant (such as chitosan acetate or chitosan lactate) and about 10 to about 50 mg/liter of co-precipitant (such as ferric chloride) may be added to 300 NTU wastewater. As another non-limiting example, about 5 to about 10 mg/liter of a coagulant (such as chitosan acetate or chitosan lactate) and about 5 to about 10 mg/liter of co-precipitant (such as ferric chloride) may be added to 500 NTU wastewater. As another non-limiting example, an amount in the range of about 0.5 to about 10 mg/liter of a coagulant (such as chitosan acetate or chitosan lactate) and an amount in the range of about 5 to about 50 mg/liter of co-precipitant (such as ferric chloride) may be added to wastewater.

In the illustrated embodiment, the settling tank 24 is a two-tiered settling tank configured for holding 20,000 gallons of wastewater. Wastewater from the holding tank 22 enters the settling tank 24 at inlet 40 located on the bottom of the tank 24, and settled wastewater is skimmed from the top surface of the settling tank 24 at outlet 42 by pump 44. If the treatment system 20 has an exemplary flow rate of about 500 gpm, then the typical holding time of the waste water in the 20,000 gallon settling tank 24 is about 40 minutes. In one embodiment of the present disclosure, the holding time in the settling tank 24 may be selected from the group consisting of less than 1 hour, less than 2 hours, and less than 3 hours.

In one embodiment of the present disclosure, the settling tank process may be configured to remove about 90% of the turbidity in the original wastewater. It should be appreciated that the addition of an additive greatly decreases the amount of time that it would take to settle the turbidity without an additive. Settling without additives generally requires a time period on the order of days or weeks, not on the order of minutes or hours, as described in the present disclosure. Therefore, the presence of additives greatly decreases the processing time of the system 20, which is imperative in a high flow system, for example, a flow rate in the range of about 50 to about 500 gpm, or higher.

The deposit that is settled out in the settling tank 24 may be dewatered and put aside or stored for further processing, for example, to further isolate the components and recover any precious metal particles. It should be appreciated that a portion of dissolved precious metals may also be captured in the settling tank 24 or the backwash from the filter system 26. In one embodiment of the present disclosure, the deposit from the settling tank 24 may include up to about 25% of the dissolved precious metals. If greater than 25%, the additive mixture may need to be reassessed for effectiveness. In another embodiment of the present disclosure, the deposit from the settling tank 24 may include about 5% to about 10% of the dissolved precious metals.

After exiting the settling tank 24, the settled wastewater travels to a filter system 26 through line 46, where it is processed through a suitable filtering process. In one embodiment of the present disclosure, the filter system 26 is configured to decrease the degree of turbidity to less than about 5 NTU.

The inventors have found that injection of a coagulant, such as chitosan, into the settled wastewater before filtration improves the filtration process. Therefore, line 60 delivers additional coagulant to the settled wastewater as it exits the settling tank 24 at outlet 42. In the illustrated embodiment, the coagulant line 60 injects coagulant prior to the pump 44 to generate mixing of the coagulant with the settled wastewater. In one embodiment of the present disclosure, the supplemental coagulant is added to the settled wastewater in a range of about 0.5 mg/liter to about 2 mg/liter.

In one embodiment of the present disclosure, the filter system 26 may be a pressure sand filter, for example, a Yardney 54/4 sand filter that is able to process an exemplary flow rate of 500 gpm or more. The coagulant and wastewater mixture may be pumped into the pressure sand filter, where the particulate material and nuisance metals are trapped and the filtered water is allowed to pass through the filter system 26. In general, a sand filter system can process a wastewater having a turbidity of about 50 NTU or less. However, depending on the nature of the turbidity, the sand filter system may be configured to process a wastewater having up to a turbidity of about 300 NTU or less.

At the outlet 50 of the filter system 26, filtered water exits and travels via line 52 to the metal recovery system 28. Periodically, the filter system 26 may be backwashed. Backwash water from the filter system 26 may be returned via line 54 to the settling tank 24, particularly if there may be recoverable amounts of precious metals in the backwash.

After the wastewater has been treated to essentially remove turbidity to a degree of about 99+% removal (e.g., less than about 5 NTU), the filtered water can be processed through a metal recovery system 28, which is designed to adsorb metals using an adsorptive media. In the case of precious metal recovery, the adsorptive media may be specifically designed to adsorb gold, silver, platinum, or palladium.

In one embodiment of the present disclosure, precious metals may be adsorbed using MetalZorb® brand adsorptive media. MetalZorb® adsorptive media can adsorb any of the following metals: gold, uranium, cadmium, mercury, copper, lead, vanadium, molybdenum, zinc, chloride, nickel, selenium, arsenic, cobalt, manganese, iron, silver, aluminum, magnesium, and potassium. If multiple metals are adsorbed by the media, the metals can later be recovered and separated, if desired. However, MetalZorb® adsorptive media is considered to be very effective at adsorbing gold. It should be appreciated that other adsorptive media are also within the scope of the present disclosure.

In one embodiment of the present disclosure, the metal recovery system 28 is suitably sized such that the holding time in the metal recovery system 28 is less than 3 minutes. In that regard, with an exemplary flow rate of 500 gpm, the metal recovery system 28 may be sized to hold about 1500 gallons. In other embodiments of the present disclosure, the holding time in the metal recovery system 28 may be less than 2 minutes or less than 1 minute.

In accordance with one embodiment, the load rate of the adsorptive media may be in the range of about 10% to about 25% based on the weight of the system 28, depending on the presence and concentration of competing metal ions and/or residual particulate material. In accordance with another embodiment, the load rate of the adsorptive media may be in the range of about 10% to about 15% based on the weight of the system 28, also depending on the presence and concentration of competing metal ions and/or residual particulate material.

Experimental results show that more than 95% of dissolved gold in the filtered wastewater can be recovered by MetalZorb® adsorptive media when used in conjunction with the systems and methods described herein. When the adsorptive media has reached its adsorption maximum, the media can be removed from the metal recovery system 28 and processed to isolate the precious metal ions. The system 20 can be analyzed for gold ions that are escaping from the metal recovery system 28. If the amount is significant, for example, greater than 5% of the expected gold recovery, the metal recovery system 28 is indicating that the adsorptive media needs to be replaced.

Although described with reference to the recovery of precious metals, it should be appreciated that the system 20 of the FIGURE may also be used to process industrial wastewater, storm water, scrubbing waste water, or other types of wastewater, as opposed to mining wastewater. An industrial wastewater system will include substantially the same components as the system 20 of the FIGURE, including a wastewater holding tank 22, a settling tank 24, a filter system 26, and a metal recovery system 28. However, the metal recovery system 28 is designed to collect any metals that may have not been removed during the settlement and filtration processes, and not necessarily precious metals. Further, the metal recovery system 28 in an industrial wastewater system is designed to dispose of the collected metals, and not to hold them for further processing and isolation. With toxic materials removed, the final filtrate can be discharged to surface water meeting environmental regulations.

### Example

A test sample volume of 10 gallons (37.8 liters) was collected from a construction site storm water detention pond to ensure adequate levels of suspended sediment (˜500 NTU) and natural mineral-based metals as well as calcium, magnesium, sodium, etc.

A 10 gallon (37.9 liter) tank was used to perform the pretreatment chitosan lactate turbidity treatment and nuisance metal ion co-precipitation treatment with ferric chloride. A Neptune brand 1/20th HP impeller-type mixer provided agitation. The water was initially spiked with ˜3.5 mg/l soluble gold. After pretreatment, the solution was filtered (simulated sand filtration) and the clarified effluent was returned to the treatment tank.

Gold adsorptive media was added to the filtered solution while mixing and samples of the water were extracted from the tank at succeeding time intervals for gold analysis. Gold concentrations were compared to the starting ˜3.5 mg/l level so that gold absorption percentages and rates could be calculated. Gold concentrations at different time intervals were used to calculate the likely contact time required in a commercial operation. The contact time can be used to determine how much adsorptive media will be needed to support commercial level flow rates.

An amount of 970 mg of reagent-grade gold chloride (30% gold chloride by weight) was added to 37.8 liters of test water. The gold solution contained 19.48% gold; therefore, 970 mg of the solution contains 189 mg of gold (0.1948×970 mg=189 mg gold). An amount of 189 mg of gold in 37.8 liters of test water equals 5 mg/l gold (189 mg÷37.8 liters=5 mg/l final gold concentration).

1. The turbid test water was added to the mixing tank and the mixer started. Then, 970 mg of the gold solution was added and mixed for 5 minutes. Two 500 ml samples were collected; one for gold analysis and the other for an ICP-MS scan (see Table 1).

2. 5 mg/l chitosan lactate (0.2 grams) plus 10 mg/l ferric chloride (0.4 grams) was added, mixed for 15 minutes and then allowed to settle.

3. The supernatant was filtered through an 8-inch string-wound filter (25 micron) with the filtrate being returned to the cleaned 10-gallon tank (simulating sand filtration).

4. Two 500 ml samples were collected; one for gold analysis and the other for an ICP-MS scan.

5. 1.67 lbs of gold adsorptive media (2% by wt.) was added and mixed for 30 seconds then one 500 ml sample was collected for gold analysis (see Table 2).

6. The mixer was activated for another 30 seconds (total 1 minute) then sampled for gold again.

7. The mixer was activated for another 1 minute (total 2 minutes) then sampled for gold.

8. The mixer was activated for another 1 minute (total 3 minutes) then sampled for gold.

The results of the test are provided in the following tables.

TABLE 1
Nuisance Metals Removal Efficiency with Chitosan
Coagulation and Ferric Chloride Co-Precipitation.

| Analyte | Before Treatment | After Treatment | % Removal |
|---|---|---|---|
| Gold (μg/l) | 3,480 | 3,150 | 9.5% |
| Turbidity | 510 NTU | 0.8 NTU | 99.8% |
| Aluminum (μg/l) | 8,720 | 136 | 98.4% |
| Barium (μg/l) | 59.5 | 9.3 | 84.4% |
| Copper (μg/l) | 39.5 | <2.0 | >95% |
| Iron (μg/l) | 4,280 | <10 | >99.8 |
| Phosphorus (μg/l) | 346 | <20 | >94.2% |
| Silicon (μg/l) | 6,130 | 2,450 | 60.0% |
| Titanium (μg/l) | 59.0 | <1 | >98.3% |
| Zinc (μg/l) | 25.0 | 7.0 | 72% |

The ability of the nuisance metals removal (chitosan/ferric chloride treatment) was very successful with a high of >99.8% removal of iron and a low of 60% removal for silicon. The average percent reduction of these elements plus turbidity was 89.1% while the soluble gold fraction was reduced by only 9.5% (which is the point of the treatment).

TABLE 2
Rate of Soluble Gold Adsorption.

| Adsorption Time | | |
|---|---|---|
| (minutes) | Gold Concentration | % Adsorption |
| 0 - start | 3,480 (μg/l) | 0% |
| 0.5 | 94.4 (μg/l) | 97% |
| 1 | 78.7 (μg/l) | 98% |
| 2 | 62.4 (μg/l) | 98% |
| 3 | 113 (μg/l) | 97% |

Gold adsorption onto the media was extremely rapid with 97% of available gold adsorbed within the first 30 seconds of exposure. This implies a very high adsorptive efficiency. For example, processing water at 500 gpm with 0.5 mg/l soluble gold for 24 hours would recover 81.5 ounces of gold out of the total available 84 ounces present in the water.

While illustrative embodiments have been illustrated and described, it will be appreciated that various changes can be made therein without departing from the spirit and scope of the disclosure.

The embodiments of the disclosure in which an exclusive property or privilege is claimed are defined as follows:

1. A method of treating wastewater, the method comprising:
(a) treating the wastewater with an additive to generate a treated wastewater;
(b) filtering the treated wastewater through a filter system to substantially completely remove residual particulate material and generate filtered wastewater; and
(c) processing the filtered wastewater with an ion exchange media to adsorb soluble metals from the filtered wastewater.

2. The method of claim 1, wherein the additive is selected from the group consisting of a coagulant, a co-precipitant, and a mixture thereof.

3. The method of claim 2, wherein the coagulant is selected from the group consisting of chitosan, alum, and aluminum chloride.

4. The method of claim 2, wherein the co-precipitant is selected from the group consisting of ferric chloride, aluminum chloride, and alum.

5. The method of claim 1, wherein the filtering system includes a pressure sand filter.

6. The method of claim 1, wherein the ion exchange media is MetalZorb® adsorptive media.

7. The method of claim 1, wherein the filtered wastewater is processed with the ion exchange media for a time period selected from the group consisting of less than 1 minute, less than 2 minutes, and less than 3 minutes.

8. The method of claim 1, wherein the wastewater flows at a rate in a range of about 50 to about 500 gpm.

9. The method of claim 1, wherein the wastewater flows at a rate of greater than about 500 gpm.

10. The method of claim 1, further comprising desorbing metals from the ion exchange media.

11. The method of claim 8, further comprising isolating and recovering the desorbed metals.

12. A system for treating wastewater, the system comprising:
(a) a settling tank for settling sediment from wastewater, wherein the wastewater includes an additive;
(b) a filter system for filtering the settled wastewater into filtered wastewater; and
(c) an ion adsorption system for adsorbing metal ions from the filtered wastewater.

13. The system of claim 10, wherein the settling tank settles at least about 90% of the sediment present in wastewater.

14. The system of claim 10, wherein the filter system filters the sediment present in the settled wastewater to less than about 5 NTU of turbidity present in filtered wastewater.

15. The system of claim 10, wherein the holding time in the settling tank is selected from the group consisting of less than 1 hour, less than 2 hours, and less than 3 hours.

16. The system of claim 10, wherein the holding time in the ion adsorption system is selected from the group consisting of less than 1 minute, less than 2 minutes, and less than 3 minutes.

17. The system of claim 10, wherein the additive is selected from the group consisting of a coagulant, a co-precipitant, and a mixture thereof.

18. The system of claim 10, wherein the ion adsorption system includes adsorptive media in a range selected from the group consisting of about 10% to about 25% by weight, and about 10 to about 15% by weight.

19. The system of claim 10, wherein the system is configured to receive a wastewater flow at a rate in a range of about 50 to about 500 gpm.

20. A system for treating wastewater, the system comprising:
(a) a settling tank for settling sediment from wastewater, wherein the wastewater includes an additive selected from the group consisting of a coagulant, a co-precipitant, and a mixture thereof, and wherein the settling tank settles at least about 90% of the sediment present in wastewater;
(b) a filter system for filtering the settled wastewater into filtered wastewater, wherein the filter system filters the sediment present in the settled wastewater to less than about 5 NTU of turbidity present in filtered wastewater; and
(c) an ion adsorption system for adsorbing metal ions from the filtered wastewater.
